(19) United States
(12) Patent Application Publication
(10) Pub. No.: US 2020/0255694 A1
(43) Pub. Date: Aug. 13, 2020

(54) Shrink-wrap film and method for jacketing elongated items, especially leads

(71) Applicant: TESA SE, Norderstedt (DE)

(72) Inventors: Kerstin KLINGEBERG, Hamburg (DE); Lars GULBRANDSEN, Barsbüttel (DE); Heike SIMONIS, Hamburg (DE)

(21) Appl. No.: 16/784,888

(22) Filed: Feb. 7, 2020

(30) Foreign Application Priority Data
Feb. 8, 2019 (DE) 10 2019 103 121.4

(51) Int. Cl. C09J 5/06; C09J 7/38; C09J 7/25; H01B 7/00; H01B 13/012; H01B 13/06

(52) U.S. Cl. CPC C09J 5/06; C09J 7/385; C09J 7/25; C09J 2483/006; H01B 13/01209; H01B 13/06; C09J 2433/00; H01B 7/0045

(57) ABSTRACT

The present invention relates to an adhesive tape and to a method for jacketing an elongated item, more particularly cable sets. The adhesive tape must cure within the operational dictates for further processing, e.g. within 6 min, and after curing must exhibit the required dimensional stability properties. However, the adhesive compositions must not cure during storage itself, since otherwise they can no longer be used. Nor may the curing temperatures be too high, since otherwise the lead insulation, which is often made of PVC, may suffer damage. The invention provides a method for jacketing an elongated item such as more particularly leads or cable sets, where a stretched shrink-wrap film is guided in a helical line around the elongated item or the elongated item is wrapped in an axial direction by the stretched shrink-wrap film, the elongated item together with the shrink-wrap film wrapping is brought into the desired disposition, more particularly into the cable set plan, the elongated item is held in this disposition and the shrink-wrap film is brought to shrink by the supply of thermal energy at a temperature of up to 130° C.

The invention relates to an adhesive tape and to a method for jacketing elongated items, especially cable sets.

Adhesive tapes have long been used in industry for producing cable looms. The adhesive tapes are employed to bundle a multiplicity of electrical leads prior to installation or in an already assembled state, in order, for example, to reduce the space taken up by the bundle of leads, by bandaging them, and additionally to achieve protective functions such as protection from mechanical and/or thermal stressing. Common forms of adhesive tapes comprise film carriers or textile carriers, which in general are coated on one side with pressure sensitive adhesives. Adhesive tapes for the wrapping of elongated items are known from, for example, EP 1 848 006 A2, DE 10 2013 213 726 A1, and EP 2 497 805 A1.

The present cable sets swathed with adhesive tape are generally flexible. This flexibility is often undesirable, however, for technical reasons associated with manufacture. In manufacture, the cable harnesses are generally prefabricated to make up a cable plan, and then inserted into the object which is to be equipped—such as motor vehicles, for example. A cable set plan corresponds to the actual three-dimensional disposition of the individual cable harnesses in the cable set—that is, which cable harness is bent at which point in which angle, where positions of branches or outbindings are located, and with which connectors the ends of the cable harnesses are fitted.

In order to hold the individual harnesses of the cable set in a defined shape, allowing them to be guided around the engine in the engine compartment, for example, without coming into contact with the engine, it is usual to mount injection-moulded components subsequently around the cable loom swathed with adhesive tape. A disadvantage of these injection-moulded components, however, is that they entail additional material and additional assembly effort.

WO 2015/004190 A1 discloses a method for jacketing elongated items such as, more particularly, leads or cable sets, wherein the elongated item is wrapped with an adhesive tape, with curable adhesive applied thereon, in a helical line or in an axial direction, and the adhesive applied on the adhesive tape is cured by supply of radiant energy such as heat. For the thermal curing in that case a temperature of 175° C. is employed.

A disadvantage of that method is the high curing temperature, which is of little practicability in the assembly of cable harnesses during the manufacturing operation in the automotive industry, for example, especially since the cable insulation, which is often fabricated from PVC, may be damaged. Consequently, cable plans have to date been laid in prefabricated, injection-moulded shapes. This entails a high level of manufacturing effort.

Desirable tapes are therefore those which stiffen at 130° C. at most, preferably 120° C. at most, and more preferably between 60° C. and 100° C., allowing the wrapping of adhesive tapes to be integrated into the operation of manufacturing the cable looms or cable plans. The adhesive tapes must after curing exhibit the required dimensional stability properties. Moreover, the adhesives must not cure during storage itself, since otherwise they are no longer usable. Lastly, curing is to take place within the cycle time of the production operation (around 6 minutes).

It is therefore an object of the present invention to provide an adhesive tape for jacketing elongated items that meets the requirements described above. Another object of the present invention is to provide a method for wrapping elongated items using the rigid adhesive tape of the invention, and also a product obtainable with the method.

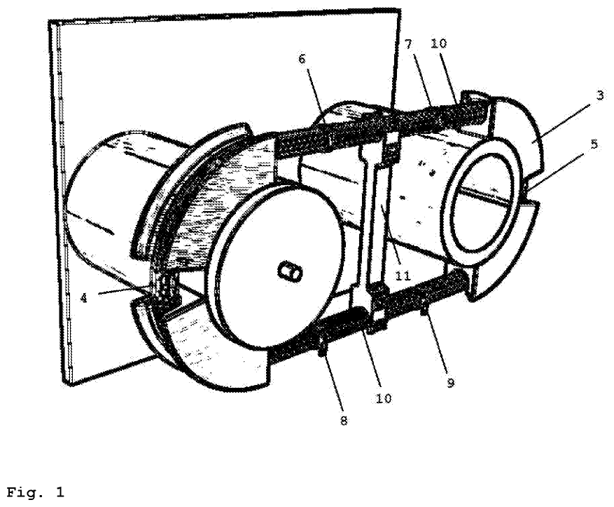

FIG. 1 depicts a wound cable set.

Proposed as a solution to the technical problems is a method for jacketing an elongated item such as more particularly leads or cable sets, where a stretched shrink-wrap film is guided in a helical line around the elongated item or the elongated item is wrapped in an axial direction by the stretched shrink-wrap film, the elongated item together with the shrink-wrap film wrapping is brought into the desired disposition, more particularly into the cable set plan, the elongated item is held in this disposition and the shrink-wrap film is brought to shrinkage by the supply of thermal energy at a temperature of up to 125° C. The shrink-wrapping temperature is preferably between 100° C. and 120° C.

According to one embodiment of the invention, the elongated item is a cable harness which comprises a bundle of a plurality of cables, such as 3 to 1000 cables, preferably 10 to 500 cables, more particularly between 50 and 300 cables.

One embodiment of the invention uses a shrink-wrap film having a longitudinal shrinkage of 30% to 75%, preferably 50% to 70%. The shrinkage in the cross-direction plays only a minor part. The shrinkage ratio (longitudinal/cross) is therefore preferably between 80:20 and 50:50. A further embodiment of the invention uses a shrink-wrap film having a shrinkage force of 1.1 N to 1.8 N.

The shrink-wrap film may be a single-layer film or multi-layer film. In one further embodiment of the invention, the shrink-wrap film has a tensile strength of 30 N/mm² to 1500 N/mm², preferably of 100 N/mm² to 500 N/mm² in machine direction. The tensile strength is determined according to DIN-EN-ISO 527-3/2/300.

In one embodiment of the invention, the shrink-wrap film is first oriented at least in machine direction, preferably at a temperature from 10° C. to 60° C. below the melting point of the shrink-wrap film, before it wraps the elongated item. It is further preferred for the shrink-wrap films to be oriented with a stretching rate of 1:1.5 to 1:10 at least in machine direction.

Shrink-wrap films are polymer films which shrink in one or both directions when heat is applied. They are widely used as packaging and wrapping materials for both small and large products (e.g. pallets for industry, bottles, magazines, etc.), with thicker films used in general for larger articles and thinner films for smaller articles.

In a further embodiment of the invention, the shrink-wrap film comprises a polymer selected from oriented polystyrene (OPS films), polyvinyl chloride (PVC films), polyethylene (PE films), such as low-density polyethylene (LDPE) as described in DE 60 304 353 T2, incorporated here by reference, or medium-density polyethylene (MDPE), ethylene copolymers, especially ethylene-α-olefin copolymers, polylactic acids (PLA films), and polyesters such as polyethylene terephthalate (PET films). The shrink-wrap films preferably have a thickness of 20 μm to 100 μm, more preferably of 30 μm to 60 μm.

An example of a suitable polylactic acid shrink-wrap film is available under the trade name Nativia® NTSS from Taghleef Industries, United Arab Emirates.

In a further embodiment of the invention, the shrink-wrap film additionally further comprises a pressure sensitive adhesive, meaning that the tape is fixed on the elongated item after wrapping and before shrinking.

The adhesive is a pressure sensitive adhesive (PSA), in other words an adhesive which even under relatively weak applied pressure allows durable bonding to virtually all substrates and which after use can be detached from the substrate again substantially without residue. A PSA has a permanent pressure-sensitive tack at room temperature, thus possessing sufficiently low viscosity and a high touch stickiness, and so it wets the surface of the bonding substrate in question even at low applied pressure. The bondability of the adhesive derives from its adhesive properties, and the redetachability from its cohesive properties.

In accordance with the invention, the pressure sensitive adhesive used is a structural adhesive (construction adhesive, assembly adhesive) (see Römpp, Georg Thieme Verlag, document coding RD-19-04489, last update: September 2012). According to DIN EN 923: 2006-01, structural adhesives are adhesives forming bonds capable of sustaining in a structure a specified strength for a defined longer period of time (according to the ASTM definition: “bonding agents used for transferring required loads between adherends exposed to service environments typical for the structure involved”). They are therefore adhesives for bonds which are highly robust both chemically and physically, and in the cured state they contribute to strengthening the bonded substrates and are used for producing structures made from metals, ceramic, concrete, wood or reinforced plastics. The structural adhesives of the invention are based in particular on reactive adhesives (phenolic resins, epoxy resins, polyimides, polyurethanes and others).

Preferred PSAs are those as described in published European patent applications EP 2 520 627 A1, EP 2 522 705 A1, EP 2 520 628 A1, EP 2 695 926 A1, EP 2 520 629 A1 and EP 3 433 330 A1, incorporated here by reference.

According to one first embodiment the PSA is in the form of a dried polymer dispersion, and the polymer being composed of: 5 to 25 wt %, preferably 10 to 22 wt % of ethylene, 30 to 69 wt %, preferably 40 to 60 wt %, of alkyl acrylate esters with C₄ to C₁₂ alkyl radicals, 20 to 55 wt %, preferably 28 to 38 wt %, of vinyl acetate, 0 to 10 wt % of other ethylenically unsaturated compounds, and the PSA contains between 15 and 100 parts by weight of a tackifier (based on the mass of the dried polymer dispersion), as described in EP 2 520 627 A1. Preferably the alkyl acrylate ester is n-butyl acrylate and/or 2-ethylhexyl acrylate. Other ethylenically unsaturated compounds encompass alkyl (meth)acrylates, preferably C₁ to C₂₀ alkyl (meth)acrylates with the exception of the monomers forming the alkyl acrylate esters with C₄ to C₁₂ alkyl radicals; aromatic vinyl monomers such as styrene, α-methylstyrene and vinyltoluene, C₁ to C₁₀ hydroxyalkyl (meth)acrylates such as, in particular, hydroxyethyl or hydroxypropyl (meth)acrylate, vinyl esters of carboxylic acids containing up to 20 carbon atoms, such as vinyl laurate, vinyl ethers of alcohols containing up to 10 carbon atoms, such as vinyl methyl ether or vinyl isobutyl ether, vinyl halides such as vinyl chloride or vinylidene dichloride, acid amides such as acrylamide or metacrylamide, and unsaturated hydrocarbons having 3 to 8 carbon atoms such as propene, butadiene, isoprene, 1-hexene or 1-octene, or mixtures thereof. A further monomer which may be added to the polymer advantageously is a monomer having a functionality of two or more, added preferably at 0 to 2 wt % and more preferably at 0 to 1 wt %. Examples of polyfunctional ethylenically unsaturated monomers (e) are divinylbenzene, alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate and tetraacrylates such as pentaerythritol tetraacrylate. The polymer dispersion is prepared by the process of emulsion polymerization of the stated components. Particularly preferred embodiments and extensive descriptions of the ingredients and also of the preparation processes are found in EP 0 017 986 B1 and also EP 0 185 356 B1.

According to one further embodiment, the PSA is in the form of a dried polymer dispersion, the polymer being composed of: (a) 90 to 99 wt % of n-butyl acrylate and/or 2-ethylhexyl acrylate, preferably 2-ethylhexyl acrylate, (b) 0 to 10 wt % of an ethylenically unsaturated monomer having an acid or acid anhydride function, (c) 10 to 1 wt % of one or more ethylenically unsaturated monofunctional monomers different from (a) and (b), such as acrylonitrile and/or metacrylonitrile, (d) 0 to 1 wt % of a monomer having a functionality of two or more, and the PSA contains between 15 and 100 parts by weight of a tackifier (based on the mass of the dried polymer dispersion), as described in EP 2 522 705 A1. One particularly preferred embodiment of the invention thus encompasses a mixture of 2-ethylhexyl acrylate as monomer (a) and acrylonitrile as monomer (c). Contemplated advantageously as monomer (b) is, for example, acrylic acid, methacrylic acid, itaconic acid, maleic acid, fumaric acid and/or maleic anhydride. Preference is given to acrylic acid or methacrylic acid, optionally the mixture of both. Examples of polyfunctional ethylenically unsaturated monomers (d) are divinylbenzene, alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate and tetraacrylates such as pentaerythritol tetraacrylate. The polymer dispersion is produced by the process of emulsion polymerization of the stated components. Descriptions of this process are described—given for example—in EP 1 378 527 B1.

According to one further embodiment, the PSA is in the form of a dried polymer dispersion, the polymer being composed of: (a) 40 to 90 wt % of n-butyl acrylate and/or 2-ethylhexyl acrylate, preferably (b) 2-ethylhexyl acrylate, 0 to 10 wt % of an ethylenically unsaturated monomer having an acid or acid-anhydride function, (c) 60 to 10 wt % of one or more ethylenically unsaturated monofunctional monomers different from (a) and (b), (d) 0 to 1 wt % of a monomer having a functionality of two or more, and the PSA contains between 15 and 100 parts by weight of a tackifier (based on the mass of the dried polymer dispersion) as described in EP 2 520 628 A1. Contemplated advantageously as monomer (b) is, for example, acrylic acid, methacrylic acid, itaconic acid, maleic acid, fumaric acid and/or maleic anhydride. Preference is given to acrylic acid or methacrylic acid, optionally the mixture of both. Monomers (c) include alkyl (meth)acrylates, preferably C₁ to C₂₀ alkyl (meth)acrylates with the exception of the monomers forming (a); aromatic vinyl monomers such as styrene, α-methylstyrene and vinyltoluene, C₁ to C₁₀ hydroxyalkyl (meth)acrylates such as, in particular, hydroxyethyl or hydroxypropyl (meth)acrylate, vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, acid amides such as acrylamide or methacrylamide, and unsaturated hydrocarbons having 2 to 8 carbon atoms such as ethylene, propene, butadiene, isoprene, 1-hexene or 1-octene. Ethyl acrylate is particularly preferred in the invention. Examples of polyfunctional ethylenically unsaturated monomers (d) are divinylbenzene, alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate and tetraacrylates such as pentaerythritol tetraacrylate. The polymer dispersion is prepared by the process of emulsion polymerization of the stated components. Descriptions of this process are described, given for example, in EP 1 378 527 B1.

According to one further embodiment the PSA is in the form of a dried and electron beam (EBC) crosslinked polymeric acrylate dispersion, especially in aqueous acrylate dispersion, preferably having a gel value of greater than or equal to 40%, determined by Soxhlet extraction, where the polymeric acrylate dispersion comprises polymers composed of (a) monomeric acrylates and optionally (b) ethylenically unsaturated comonomers which are not acrylates, with the PSA containing between 15 and 100 parts by weight of a tackifier (based on the mass of the dried polymeric dispersion) as described in EP 2 695 926 A1.

According to one further embodiment, the PSA has a shear viscosity at a temperature of 25° C. during coating from dispersion of 200 to 100 000 Pa·s at a shear rate of 10⁻² s⁻¹ and 0.1 to 10 Pa·s at a shear rate of 100 s⁻¹. The PSA consists preferably of an aqueous acrylate dispersion, in other words a polyacrylic ester in fine dispersion in water and having pressure-sensitive adhesive properties, as are described for example in the Handbook of Pressure Sensitive Technology by D. Satas. Acrylate PSAs are typically radically polymerized copolymers of alkyl acrylates or alkyl methacrylates of C₁ to C₂₀ alcohols such as, for example, methyl acrylate, ethyl (meth)acrylate, n-butyl (meth)acrylate, t-butyl (meth) acrylate, cyclohexyl (meth) acrylate, 2-ethylhexyl (meth)acrylate, n-octyl (meth)acrylate, isooctyl (meth)acrylate, n-decyl (meth)acrylate, n-dodecyl (meth)acrylate, tetradecyl (meth)acrylate, lauryl (meth)acrylate, oleyl (meth)acrylate, palmityl (meth)acrylate and stearyl (meth)acrylate as well as further (meth)acrylic esters such as isobornyl (meth)acrylate, benzyl (meth)acrylate, phenyl (meth)acrylate and 2-bromoethyl (meth)acrylate, alkoxyalkyl (meth)acrylates such as ethoxyethyl (meth)acrylate. Further included are esters of ethylenically unsaturated dicarboxylic and tricarboxylic acids and anhydrides, such as ethyl maleate, dimethyl fumarate and ethyl methyl itaconate. Likewise included are vinylaromatic monomers such as, for example, styrene, vinyltoluene, methylstyrene, n-butylstyrene, decylstyrene, as described in EP 2 520 629 A1.

According to one further embodiment the PSA is in the form of a dried polymer dispersion, the polymer being composed of: (a) 95.0 to 100.0 wt % of n-butyl acrylate and/or 2-ethylhexyl acrylate and (b) 0.0 to 5.0 wt % of an ethylenically unsaturated monomer having an acid or acid-anhydride function, as described in EP 2 433 330 A1. Preferably the polymer consists of 95.0 to 99.5 wt % of n-butyl acrylate and/or 2-ethylhexyl acrylate and 0.5 to 5 wt % of an ethylenically unsaturated monomer having an acid or acid-anhydride function, more preferably of 98.0 to 99.0 wt % of n-butyl acrylate and/or 2-ethylhexyl acrylate and 1.0 to 2.0 wt % of an ethylenically unsaturated monomer having an acid or acid-anhydride function. Besides the acrylate polymers recited, the PSA may additionally be admixed, as well as any residual monomers present, with the tackifiers mentioned later on below and/or with adjuvants such as light stabilizers or ageing inhibitors, in the quantities likewise stated below. In particular there are no further polymers such as elastomers in the PSA, meaning that the polymers of the PSA consist only of the monomers (a) and (b) in the specified proportions.

According to one further embodiment the PSA is in the form of a dried polymer dispersion, the polymer being composed of: (a) 97.0 to 98.0 wt % of n-butyl acrylate and/or 2-ethylhexyl acrylate, (b) 2.0 to 3.0 wt % of an ethylenically unsaturated monomer having an acid or acid-anhydride function. Preferably the polymer consists of 97.2 to 97.7 wt % of n-butyl acrylate and/or 2-ethylhexyl acrylate, more preferably n-butyl acrylate, and 2.3 to 2.8 wt % of an ethylenically unsaturated monomer having an acid or acid-anhydride function. Contemplated advantageously as monomer (b) is, for example, acrylic acid, methacrylic acid, itaconic acid, maleic acid, fumaric acid and/or maleic anhydride.

According to one further embodiment, the PSAs are crosslinker-free. “Crosslinker-free” in the sense of this invention means that no compounds capable of crosslinking are added to the PSA. As used here, the term “crosslinker” represents chemical compounds which are capable of connecting molecular chains to one another so that the two-dimensional structures are able to form intermolecular bridges and hence three-dimensionally crosslinked structures. Crosslinkers are those compounds—especially difunctional or polyfunctional and usually of low molecular mass, that under the chosen crosslinking conditions are able to react with suitable groups—especially functional groups—of the polymers to be crosslinked, and therefore link two or more polymers or polymer positions to one another (form “bridges”) and hence create a network of the polymer or polymers to be crosslinked. As a result there is generally an increase in the cohesion. Typical examples of crosslinkers are chemical compounds which within the molecule or at the two ends of the molecule have two or more identical or different functional groups and are therefore able to crosslink molecules with similar or else different structures to one another. Moreover, a crosslinker is able to react with the reactive monomer or reactive resin, as defined above, without an accompanying polymerization reaction in the actual sense. The reason is that, in contrast to the activator, as described above, a crosslinker can be built into the polymer network.

The coat weight of the adhesive applied to the carrier and/or introduced into the carrier is advantageously between 30 g/m² and 300 g/m², more advantageously between 40 g/m² and 200 g/m², particularly advantageously between 50 g/m² and 130 g/m². Introduction into the carrier, especially into a nonwoven or woven carrier, may be accomplished by impregnation.

In one embodiment, the shrink-wrap film is from 10 mm to 50 mm, preferably 15 mm to 30 mm, more particularly 20±2 mm wide.

The shrink-wrap film is preferably wrapped spirally around the elongated item with an overlap of 30% to 70%, more preferably 40 to 50%, more particularly about 50%.

Lastly, the present invention also pertains to a cable harness jacketed with the cured adhesive tape of the invention, and to a cable harness produced by the method of the invention.

### EXAMPLES

### Example 1—Production of a Shrink-Wrap Film Coated with Pressure Sensitive Adhesive

An aqueous, polymeric dispersion-based adhesive composed of 99 wt %, based on the total weight of the polymer, of 1-butyl acrylate monomer and 1 wt %, based on the total weight of the polymer, of acrylic acid is coated out by doctor blade onto a siliconized liner and dried in an oven, using a temperature profile from 95° C. to 130° C. The adhesive is subsequently laminated with a stretched OPS film 50 μm thick from RKW SE, Petersaurach, Germany, and the adhesive-laminated film is wound up to form a bale. In the last step, the bale is converted into convenient rolls with dimensions of 19 mm width and 15 linear metres.

### Example 2—Bending Test for Ascertaining the Stiffness

A test specimen consisting of 250 individual leads with a lead cross section of 0.35 mm2 was bundled using a 5 cm wide 3M Soft Cast Casting tape to form a specimen lead set, and so the specimen lead set had a diameter of 23±5 mm and a length of 300±50 mm.

The specimen lead set was wrapped spirally with the stretched shrink-wrap film according to Example 1; a further specimen lead set was wrapped spirally with a stretched Nativia NTSS 40 shrink-wrap film 20±2 mm wide; and a further specimen lead set was wrapped spirally with a stretched Petalabel Rigid PETG TDO G10F22-T52 film, ensuring an overlap of 50%. The stiffening material was subsequently shrunken by supply of thermal energy at a temperature of 120° C. Approximately 3 minutes after activation, the ultimately strength was reached and the specimen could be tested.

The shrunken specimen lead set was subjected to a bending test in order to determine the influence of the stiffening material on the stiffness. The bending test was performed on a tensile testing machine. For this test, the specimen lead set was placed onto two jaws with a spacing of 70 mm and pressed in centrally with a crosshead by a distance of 30 mm and loaded. The force required for the deformation of the measurement travel was recorded by a tensile testing machine in newtons. The testing velocity was 100 mm/min, both during loading and during unloading of the specimen lead set. The test was carried out at three different points on the lead set (start, middle and end). The bending force results from the mean value of the three individual measurements, and was evaluated in three categories as follows:

### Evaluation Categories, Three-Point Bending Test

+ highly suitable for the application (500-750 N)

○ of limited suitability for the application (400-500 N and 700-800 N)

− not suitable for the application (<400 and >800 N)

For comparison, a commercially available adhesive tape, tesa® 51036, was subjected to the same test. The results are set out in table 1 hereinafter.

### Example 3—C-Shape Testing for Determining the Stiffness at Different Temperatures

For ascertaining the stiffness of a bent cable specimen, a test method was developed (C-cable specimen bending test). To produce a C-cable specimen (see FIG. 1) a cable lead (10) with a lead cross section of 0.35 mm² is wound 100 times around a mount (1) to form a specimen lead set. The mount (1) has two opposite, semi-circular guides (2, 3) with a diameter of 120 mm, which are spaced apart with a spacing (A) of about 210 mm. The wound cable set is represented in FIG. 1.

The number of cable turns is 100. The resulting specimen lead set has a diameter of 15±5 mm and a perimeter of 690 mm. At the apices of the semicircle segments and at two linear sections (legs) in each case, the cable bundle (10) is tied together and fixed using cable ties (4, 5, 6, 7, 8, 9) with a tensile force of 210±10 N, so that after removal from the mount the cable bundle (10) possesses sufficient stiffness not to deform. To further improve the stiffness of the cable bundle (10), a support (11) is positioned between the legs of the cable bundle and is fixed likewise using cable ties.

The cable bundle (10) thus produced is removed from the mount and wrapped, with a 50% overlap, with the adhesive tape under test (width 19 mm-20 mm). Wrapping for this purpose is commenced at a cable tie (e.g. (6) or (7)) of the leg in the circle segment direction ((6)->(4) or (7)->(5)). When the wrapping reaches the cable tie (4) or (5) at the apex of the semicircle segment, the tie is removed and the winding is continued up to the next cable tie ((4)->(8) or (5)->(9)) of the opposite leg. Exactly the same procedure is carried out on the other side, on the other semicircle segment.

The specimens thus prepared are shrunken with application of thermal energy (120°). Using wire cutters, the specimens are cut adjacent to the remaining cable ties, to give two “C-shaped” cable specimens (C-cable specimens), which each also have an unwrapped section on both sides of the semi-circular wrapped section. The cut is made at the distance of the diameter (120 mm) from the apex of the semicircle segment, projected onto the circle centre.

With one piece of cable respectively, loops are tied to the leg ends of the specimens, allowing the specimen to be hung up at one end and allowing a weight to be hung on at the other end. The remaining cable ties are now removed, since they can distort the result of testing. The distance between the legs is now determined.

One of the two specimens is stored at room temperature and the other at 60° C.

A 1 kg weight is hung from the respective lower leg of the “C-test specimen”. After an hour the deflection of the cable bundle is recorded (deflection behaviour with 1 h at RT and 60° C.) and the weight is removed. After one minute the deflection is determined again (resilience behaviour 1 min at RT or 60° C.). After an hour, the deflection is then determined again and recorded (resilience behaviour 1 h at RT or 60° C.)

The values ascertained for the C-shape deformation were graded into three categories: highly suitable for the application, of limited suitability for the application, and unsuitable for the application. The categories were evaluated as follows:

### Evaluation Categories, C-Shape Bending Test (Room Temperature)

+ highly suitable for the application (<15% deflection)

○ of limited suitability for the application (>15-30%)

− unsuitable for the application (>30%)

### Evaluation Categories, C-Shape Bending Test (60° C.)

+ highly suitable for the application (<25% deflection)

○ of limited suitability for the application (>25-40%)

− unsuitable for the application (>40%)

### Evaluation Categories, C-Shape Bending Test (Resilience Behaviour at RT and 60° C.)

+ highly suitable for the application (<10% deflection)

○ of limited suitability for the application (10-30%)

− unsuitable for the application (>30%)

For comparison a commercially available adhesive tape, tesa® 51036, was subjected to the same test. The results are likewise set out in table 1 hereinafter.

TABLE 1

| | 3-point | C-shape | C-shape resilience |
|---|---|---|---|
| | bending | deformation | behaviour |
| | test | at RT | at RT |
| OPS 50 | + | + | + |
| Nativia | + | + | + |
| NTSS 40 | | | |
| Rigid | − | − | − |
| PETG TDO | | | |
| G10F22- | | | |
| T52 | | | |
| tesa ® | − | − | − |
| 51036 | | | |

| | C-shape | C-shape resilience |
|---|---|---|
| | deformation at | behaviour at |
| | 60° C. | 60° C. |
| OPS 50 | + | + |
| Nativia | + | + |
| NTSS 40 | | |
| Rigid | − | − |
| PETG TDO | | |
| G10F22- | | |
| T52 | | |
| tesa ® | − | − |
| 51036 | | |

Key:
+ highly suitable for the application
◯ of limited suitability for the application
− unsuitable for the application

1. A method of jacketing an elongated item wherein, in the method, a stretched shrink-wrap film is guided in a helical line around the elongated item or, the elongated item is wrapped in an axial direction by the stretched shrink-wrap film, and the elongated item together with the shrink-wrap film wrapping is brought into a desired disposition, wherein the elongated item is held in said disposition and the shrink-wrap film is brought to shrinkage by the application of thermal energy supplied at a temperature of up to 130° C.

2. The method of claim 1, wherein the shrink-wrap film is brought to shrinkage by the application of thermal energy supplied at a temperature from 55° C. up to 120° C.

3. The method of claim 1, wherein shrink-wrap film is oriented at least in a machine direction before it wraps the elongated item.

4. The method of claim 3, wherein the shrink-wrap film is oriented at a temperature of from 10° C. to 60° C. below the melting point of the shrink-wrap film.

5. The method of claim 3, wherein the shrink-wrap film is oriented with a stretching rate of from 1:1.5 to 1:10 at least in the machine direction.

6. The method of claim 1, wherein the shrink-wrap film additionally further comprises a pressure sensitive adhesive.

7. The method of claim 1, wherein the shrink-wrap film has a width of from 10 mm to 50 mm.

8. The method of claim 1, wherein the shrink-wrap film is wrapped around the elongated item spirally with an overlap of from 30% to 70%.

9. A cable harness jacketed with an adhesive tape, the adhesive tape comprising a shrink-wrap film having been shrunk by the application of thermal energy supplied at a temperature of up to 130° C.

10. A cable harness produced by the method of claim 1.

11. The method of claim 1, wherein the elongated item is a lead or cable set.
